(19) United States
(12) Patent Application Publication
(10) Pub. No.: US 2002/0022983 A1
(43) Pub. Date: Feb. 21, 2002

(54) System and method for supply chain integration over computer networks

(76) Inventor: Timothy A. Barton, Overland Park, KS (US)

Correspondence Address: Niro, Scavone, Haller & Niro, Suite 4600, 181 W. Madison, Chicago, IL, 60602, US

(21) Appl. No.: 09/873,756

(22) Filed: Jun. 4, 2001

Related U.S. Application Data
(63) Continuation-in-part of application No. 09/557,822, filed on Apr. 25, 2000.
Application No. 09/557,822 is a continuation-in-part of application No. 09/303,788, filed on Apr. 30, 1999.

(51) Int. Cl. G06F 17/60

(52) U.S. Cl. 705/7

(57) ABSTRACT

A network-based marketing system is disclosed which allows an entire supply chain to obtain real-time, single-source freight services. The services are preferably provided over the Internet, and accessed via web browser software in the form of web pages automated by a web server and database server. The invention permits the users to receive rates for freight in real-time, schedule, track and invoice shipments via a distributed network, and manage all such shipments for an entire supply chain via a single master account.

This application is a continuation-in-part of pending U.S. patent application Ser. No. 09/557822 filed Apr.25, 2000, which is a continuation-in-part of pending U.S. patent application Ser. No. 09/303788 filed Apr.30, 1999.

### FIELD OF THE INVENTION

The invention claimed relates to marketing over computer networks, and particularly, to integrated service marketing to a centrally-managed supply chain over computer networks and to network marketing and provision of freight trucking services to an entire supply chain using a single interface.

### BACKGROUND OF THE INVENTION

Freight trucking services ordinarily consist of rating, scheduling, tracking, confirming, and billing. Other related services can also be provided. It is useful to be able to see or generate reports of shipments made or in progress. In addition to tracking individual shipments, it is useful for a single entity to be able to manage and view shipping activities for an entire supply chain via the use of individual subaccounts.

Manufacturers and distributors in particular face a burden of monitoring freight to or from various locations involved in production, including both internal and external locations. The present invention provides central management of all such shipping functions, as well as access to the shipping activities and functions by the individual members of the supply chain.

It is useful for all of the members of the supply chain to be potentially permitted to rate shipments. It is useful for both the members of the supply chain shipping and receiving the shipment to track the shipment, as well as permitting central management to track the shipment. It is useful to permit the member of the supply chain sending the shipment to schedule pickup and shipment. It is also useful to permit all members of the supply chain to confirm shipments and receive billing information. In particular, it is useful to permit the central management of the supply chain to modify and control the use of individual subaccounts which may be for any member of the supply chain to access any of the freight trucking services which are provided.

In the supply chain integration system, it is useful for both subaccounts and master accounts to be able to individually or collectively participate in the shipping activities which may be managed through the supply chain integration system. In addition, a single master account will permit the aggregation of discounts.

The use of a centralized supply chain integration tool promotes efficiency by the elimination of excessive telephone calls or other cumbersome contacts while maintaining centralized control and management of the entire supply chain shipping process.

While a number of specialized network-based services have been developed for target markets such as network-based auctioning, retail sales, or grocery shopping, no advanced system for providing general freight shipping services to an entire supply chain, while permitting both central oversight and management by subaccounts over a network has been developed.

### SUMMARY OF THE INVENTION

The invention provides a novel system and method for centralized management of an entire supply chain by permitting a plurality of entities to rate and schedule shipments to be sent or received by the members of the supply chain. The invention permits control of both inbound and outbound freight costs, as well as the application of group discounts to an entire supply chain, while permitting central management and information gathering capabilities along with the application of third-party discounts with respect to the entire supply chain.

Such a supply chain can consist of either purely in-house or in-company entities, or additional subaccounts may be assigned to a plurality of outside entities permitting them access to the shipping services provided to the supply chain.

The central manager can remain informed of all shipping activities throughout the entire supply chain receiving reporting features for the entire chain and a single consolidated bill or invoice for the entire supply chain.

The use of customized subaccounts permits the central manager to enroll companies or other entities as subaccounts of the master account. Each subaccount is provided a unique password for secure, identifiable access. Subsidiaries and branches can be permitted to ship to one another or to a selected variety of permitted destinations. Outside subaccounts can be permitted to ship to destinations within the company, its affiliates and branches, or other permitted destinations. Subaccounts can be limited to ship only to pre-determined destinations assigned by the master account or central manager.

Each subaccount or master account may be provided with secure access to rate, schedule, track, confirm or receive billing information regarding selected destinations.

The invention permits central management or the master account to view and control shipments between all locations involved in the supply chain.

The invention permits central management or the master account to realize savings by the use of group discounts aggregated across the entire supply chain for both incoming and outgoing shipments, whether supplied by the master account or by the service.

The invention permits the elimination of needless and wasteful paperwork and excessive overhead in scheduling, tracking and confirming shipments.

The invention permits access by both master and subaccounts to a variety of shipping carriers through a centralized service.

The invention permits both subaccounts and the master account to access activity reports when desired, either across the entire supply chain (in the case of the master account) or by subaccount (in the case of both master and subaccounts).

The master account designates any entity, such as a vendor or subsidiary, as a subaccount and provides information to the service as to whether each subaccount is permitted complete or limited access to shipping services. Limited access may be, for example, by destination. Complete access subaccounts would be permitted unlimited access to shipping services.

Only the Master Account and its authorized users have full visibility of all transactions throughout the supply chain.

### BRIEF DESCRIPTION OF THE DRAWINGS

FIG. 1 shows an overview of the system, including a user's computer, a network, and the service's server computers.

FIG. 2 shows an overall flowchart of the supply chain integrator, from a user's point of view.

FIG. 3 shows two examples of a potential supply chain.

FIG. 4 shows a main supply chain integrator page for the master account for a web-based version of the invention.

FIG. 5 shows a shipment rating page for the master account for a web-based version of the invention.

FIG. 6 shows an add/modify authorized user page for the master account for a web-based version of the invention.

FIG. 7 shows an authorized user information page for the master account for a web-based version of the invention.

FIG. 8 shows an address book management page for the master account for a web-based version of the invention.

FIG. 9 shows an address addition page for the master account for a web-based version of the invention.

FIG. 10 shows an address modification page for the master account for a web-based version of the invention.

FIG. 11 shows a query for a shipping activity report for the master account for a web-based version of the invention.

FIG. 12 shows a sample shipment log page for the master account for a web-based version of the invention.

FIG. 13 shows a complete access account management page for the master account for a web-based version of the invention.

FIG. 14 shows an add new complete access account page for the master account for a web-based version of the invention.

FIG. 15 shows a modify complete access account page for the master account for a web-based version of the invention.

FIG. 16 shows an add/modify authorized user page for subaccounts for a web-based version of the invention.

FIG. 17 shows a limited access account page for the master account for a web-based version of the invention.

FIG. 18 shows an add new limited access account page for the master account for a web-based version of the invention.

FIG. 19 shows a modify limited access account page for the master account for a web-based version of the invention.

FIG. 20 shows a view products page for the master account for a web-based version of the invention.

FIG. 21 shows an add products page for the master account for a web-based version of the invention.

### DEFINITION OF THE TERMS

The following terms are used in the claims of the patent as filed and are intended to have their broadest equivalent meaning consistent with the requirements of law.

“Account” means an individual, organization or supply chain with access to the services provided by the system. Accounts may consist of several subaccounts and a master account. A master account is the main account under which a supply chain is managed. Subaccounts are any account affiliated with the master account.

“Carrier SCAC” or “SCAC” means or any code or abbreviation used to represent a carrier.

“Carrier information” means any data or information stored in the database regarding the carriers. This may include SCAC, rate information, discount information, markup information, or any other kind of information related to a carrier.

“Computer” means a programmable device that can store, retrieve and process data. Multiple computers may be used in place of ‘a computer’ even when a single computer is referred to.

“Customer information or user information” means any data or information stored in the database regarding the customer.

“Customer” means a user who has been registered with the service, and has access to a master account or a subaccount.

“Database” means a collection of information stored in a format which allows searching by a computer, program or user. “Shipping information” means information stored in a database and used for providing shipping services, such as rates, addresses, Carrier identifiers, Carrier SCACs, product descriptions, NMFC numbers, and the like. “Account information” means information stored in a database and used for account management, such as user identifiers, passwords, user addresses, access limits (such as limited or complete), PINs and the like.

“Freight trucking” means land-based shipping of fill or partial loads by any shipping vehicle, such as a truck, automobile, panel van, or other shipping vehicle.

“Freight marketing” means the marketing of freight trucking services.

“HTML” means Hypertext Markup Language.

“LTL shipping” means “less-than-truckload” shipping, or shipping involving any size load, including specifically loads with are less than an entire truckload. This definition is meant to be inclusive rather than exclusive, and also includes loads which are equal to or greater than an entire truckload.

“Marketing” means advertising, selling, providing, or any combination thereof.

“Master Account” means an account on the Service affiliated with a supply chain. A master account grants access to the Service and the ability to manage subaccounts upon the entry of the personal identification and the password or PIN, though it may also involve any other kind of mechanism for identification of the user, such as a password or account name alone, or a name paired with a “cookie” provided by the user's computer, or any similar device.

“Network” means any computer network, including, without limitation, both private and public networks, such as IPX networks or the Internet or any other distributed network.

“NMFC number” means National Motor Freight Classification number, but may also indicate any code in any system for classifying freight shipments.

“PIN” means personal identification number.

“Programs” or “software” means any machine-operable code stored on a computer permitting it to operate or perform a function.

“Quotation” means a price quote for a service, such as a shipment.

“Rating” means quoting a price based on shipment data provided by a customer or user, such as a stated shipment type, origin, and destination.

“Shipper” means the location, entity, user, or person from which a shipment is picked up or sent.

“Subaccount” means an account affiliated with a master account which permits the subaccount's user to access the service.

“The service” means the service for providing services related to shipping and supply chain shipping management over a network such as the Internet or World Wide Web, or any other network.

“The system” means the computer hardware and software used in providing the service. In the currently preferred embodiment, this includes the server computer.

“The server” means the computer hardware used in providing the service. This may include, as in the currently preferred embodiment, a web server and a database server. The server may also be a single computer or a plurality of computers.

“Supply chain” means a group of related individuals or entities with common or related shipping needs. One example of a supply chain is a manufacturer, its subdivisions, suppliers, wholesalers and customers.

“Carrier” means an individual or organization providing freight shipping services.

“Tracking” means providing information regarding shipment status.

“User” means customer, potential customer, or other person accessing the service.

“Web browser” means any software adapted for accessing web pages or other files over the Internet or a distributed network. Examples of such software are Netscape Navigator and Internet Explorer.

Where alternative meanings are possible, the broadest meaning is intended. All words used in the claims are intended to be used in the normal, customary usage of grammar and the English language.

### DETAILED DESCRIPTION OF THE PREFERRED EMBODIMENTS

Set forth below is a description of what is currently believed to be the preferred embodiment or best example of the invention claimed. Future and present alternatives and modifications to this preferred embodiment are contemplated. Any alternatives or modifications which make insubstantial changes in function, in purpose, in structure or in result are intended to be covered by the claims of the patent.

The invention's preferred embodiment currently is a web site, and may best be understood in terms of use over the Internet. It can readily be seen, however, that the essential design of the system and the services provided by it do not require the use of a web site over the Internet, but may be implemented through the use of any server over any network, including the Internet, an IPX network, or any distributed network of computers with access to a server or computer on which the system operates. The system providing the services of the invention may comprise a number of computers, such as a web server and a database server, or a single computer performing all of the functions of the invention, so long as the user may access the functions over a network.

The present preferred embodiment of the system is the preferred embodiment given the present technology available and the kinds of networks currently in popular use, and is not meant to restrict the specification or practice of the invention in any way by reference to a specific kind of network, server, computer, or operating system. Equivalent computers, networks, or operating systems are expressly contemplated by the invention, and could be used to practice the invention.

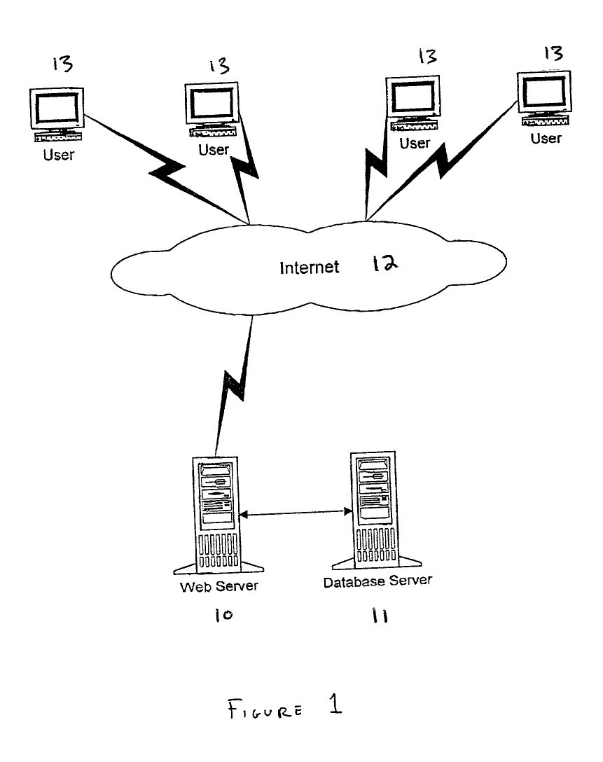

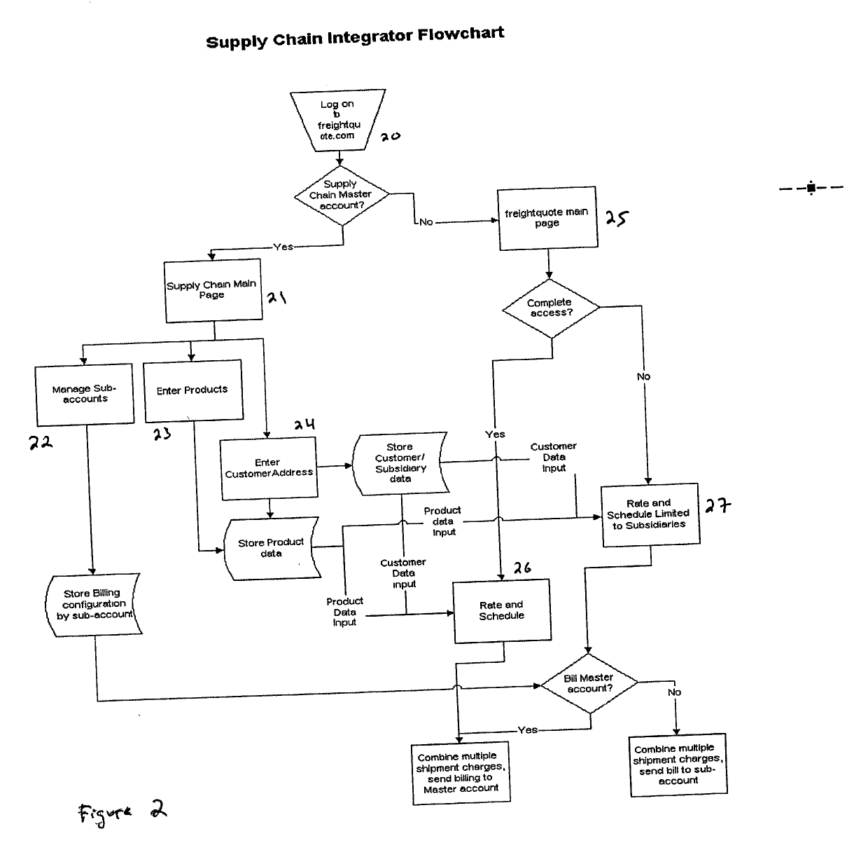

In FIG. 1, the overview of the system is shown. The system server, including web server 10 and database server 11, permits users to access the services over the Internet 12 from any user computer 13 connected to the Internet. This connection may be via modem, DSL, Ethernet or any other connection. The user connects to web server 10 using the web browser of their choice. Examples of such browser programs are Netscape Navigator or Microsoft's Internet Explorer. It can readily be seen that access may also be by dedicated connection or direct dial-in, or any web browser software could be used to access the server in an alternate embodiment. In the present embodiment, it is preferred to use Internet Explorer or Netscape Navigator, which are the two most popular browsers in common use at the present time. Web server 10 is itself connected to database server 11, which performs the storage, query, and lookup functions of the invention. It can readily be seen that a single, more powerful computer could perform the functions of both web server 10 and database server 11, or that more than two computers may be used to perform the functions of the service. Any of user computer 13, web server 10, or database server 11 may also be protected by a firewall or other device without affecting the invention, so long as the system server is accessible by the user computer. The database may be kept and required lookup functions performed via a variety of common web and database server programming methods. Individual lookup or searches of the database are not described in this description, as they are easily within the scope of one of ordinary skill in the art. The currently preferred embodiment of the invention uses Oracle 8.0 database software and Microsoft's Internet Information Serverweb server, but any similar server and database software may be used, and custom written software may be used in order to practice the invention. The use of any specific software or lookup table is not meant to limit the scope of the invention, but only as an example of the currently preferred embodiment. It is worth mention that the use of a web server and a database server or their equivalents are well known in the art, and where the specification calls for the database server, the web server, or the system, to perform a function without further description, the actual operation or programming of the system to perform the action or function described is well known in the art, and will be readily apparent to one skilled in the art. In the currently preferred embodiment, the servers used are as described, and the web pages themselves are programmed in HTML. Oracle is used to maintain the database of information, which permits the service's operators or administrators to alter the customer information, carrier information, rate information and other information stored within the database.

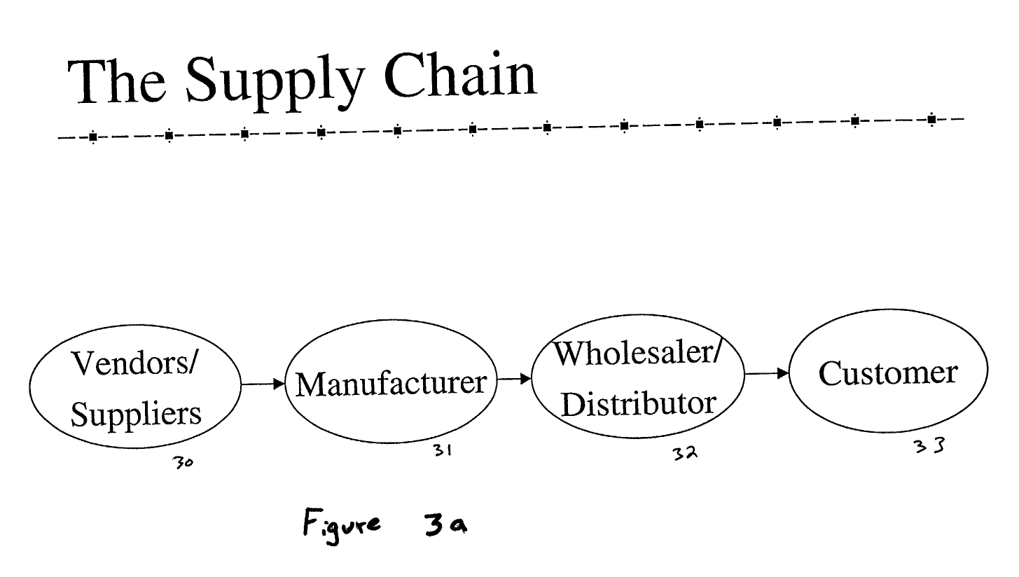

FIG. 2 shows a flowchart of a possible presentation of the system to the user, in the currently preferred embodiment. The user of either a master account or a subaccount enters the service by accessing a login page 20 via the user's web browser. If the user is a master account, the user will be directed to a supply chain main page 21 from which the user may choose to go to a manage subaccounts page 22, and enter products page 23 or enter customer addresses page 24. If the user is a subaccount or a master account who wishes to rate and schedule shipments, the user may also go to the services main page 25 from which the user may rate and schedule 26 to any destination if the user has complete access or, if the user does not, may rate and schedule to limited destinations 27.

Depending on access provided and selected by the master account, the subaccount or the master account may be billed for any shipping services provided.

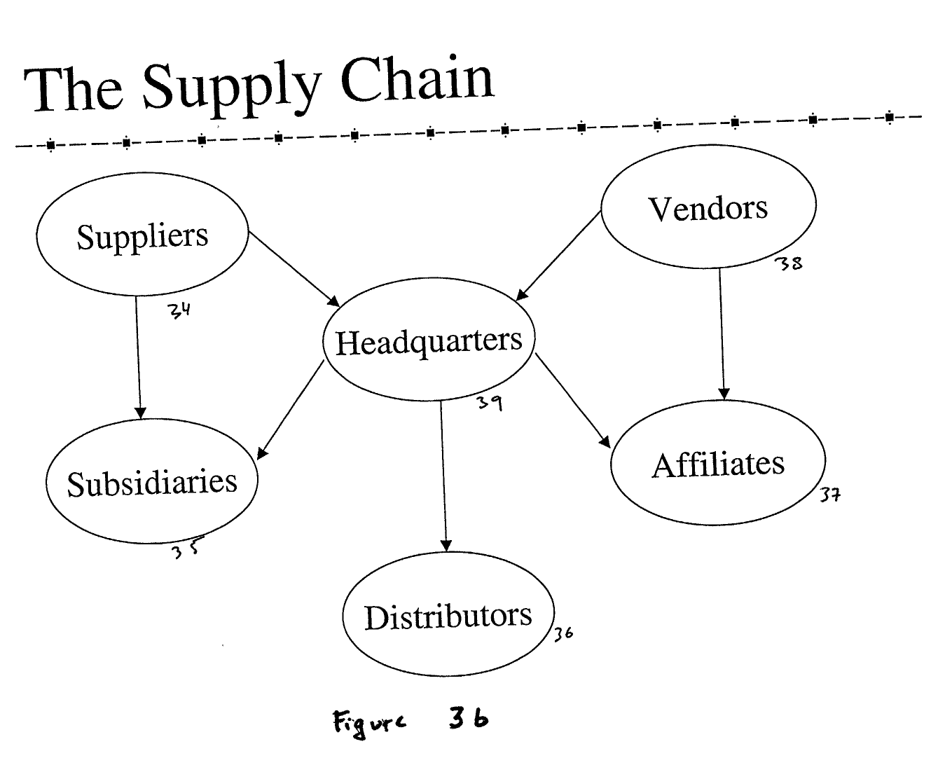

FIG. 3a shows a typical supply chain which may consist of vendors/suppliers 30, manufacturers 31, wholesalers/distributors 32 and customers 33.

FIG. 3b shows another typical supply chain which may consist of suppliers 34, subsidiaries 35, distributors 36, affiliates 37, vendors 38 and headquarters 39. It may be readily seen that a wide variety of entities may be members of an integrated supply chain and the invention encompasses all such entities.

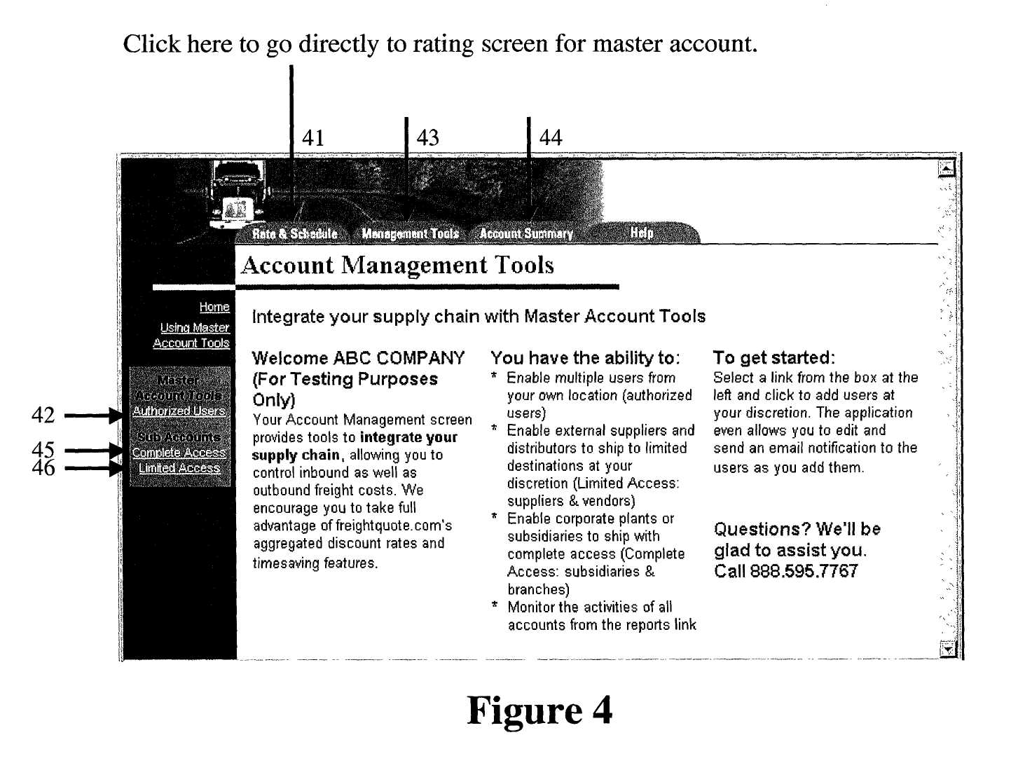

FIG. 4 shows the main supply chain integrator page for the master account. The main supply chain integrator page provides links from which the user of the master account may rate and schedule shipments (rate and schedule link 41), add or modify authorized users (modify authorized users link 42), view, add or modify products (view products link 43), and view reports or tracking logs (view logs/reports/tracking link 44). The user may also view, add or modify accounts via complete access accounts link 45 (for viewing, adding or modifying complete access accounts) or limited access accounts link 46 (for viewing, adding or modifying limited access accounts and subaccounts). This set of links also appears in each page reachable by the master account, permitting the master account easy, flexible access to all of the functions available to the master account.

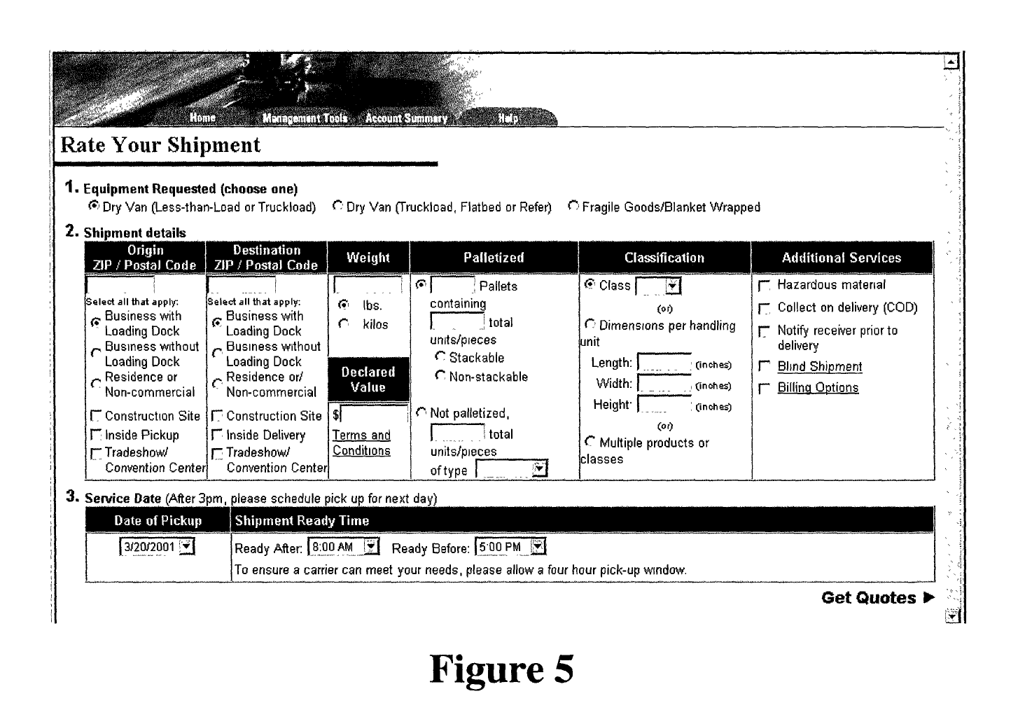

FIG. 5 shows a sample shipment rating page for the master account for a web-based version of the invention. This shipment rating page is similar to the shipment rating described in detail in pending U.S. patent application Ser. No. 09/557822 and pending U.S. patent application Ser. No. 09/303788, and, as described therein, may be performed in a variety of ways with interactions with the server as appropriate. Users of the master account may rate and ship to and from any location. Users of a complete access subaccount may also ship to and from any location. Users of a limited access subaccount may ship to and from the locations permitted to that subaccount only.

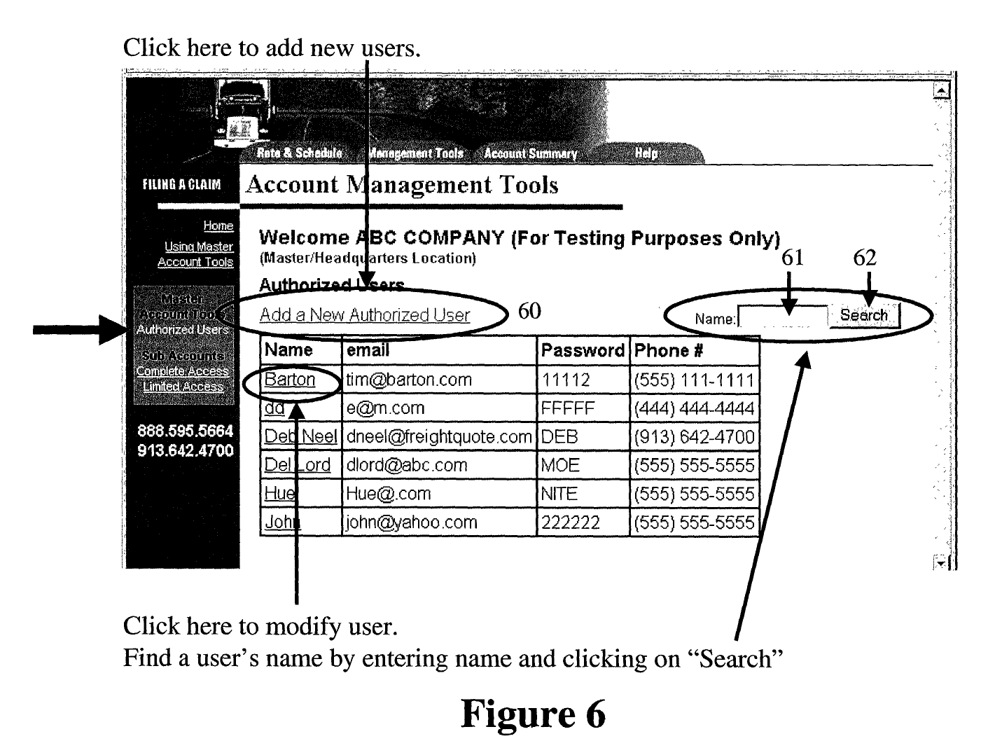

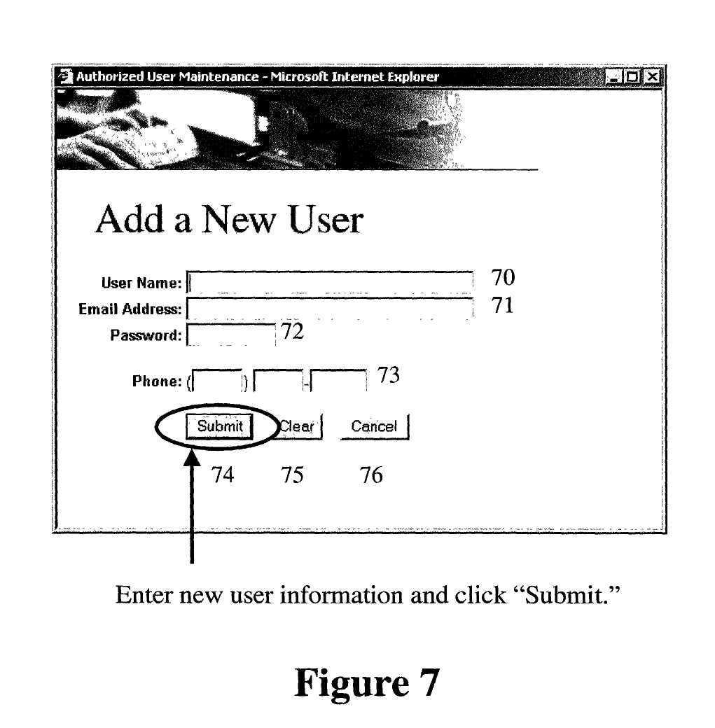

FIG. 6 shows an add/modify authorized user page for the master account for a web-based version of the invention. This page is the front end of the authorized user management portion of the invention, and through it the user of the master account may add a new authorized user by selecting the ‘Add a New Authorized User’ link 60 or seek to modify an existing authorized user by entering the existing authorized user's name in Name text box 61 and clicking search button 62. Selecting the ‘Add a New Authorized User’ link 60 will take the user to an empty ‘Add a New Authorized User’ page, as shown in FIG. 7. Performing a search for an existing user will result in a ‘Modify Company Info’ page being displayed, similar to that shown in FIG. 7, with the data for the user to be modified showing in the text boxes. Once an authorized user is added to the master account, that user will have all the access privileges to the system permitted any user of the master account.

FIG. 7 shows a new user information page for the master account for a web-based version of the invention. This page permits the user to add a new authorized user to the master account by entering the user's name in the user name text box 70, the user's email address in the user email address text box 71, and the user's password in the user password text box 72, and the user's telephone number in the user telephone number text box 73. The user of the master account may submit, clear or cancel the change or addition of the authorized user by clicking on the submit button 74, the clear button 75 or the cancel button 76. Upon entry of the appropriate data into the text boxes, and clicking the ‘submit button’, a new master account user will be added to the database by the system. A similar page is used for modification or deletion of existing users. After modification of the existing user's data by modification of the user's data placed in the text boxes by the system, the user of the master account may click on submit button 74 or its counterpart on the modify authorized users page, and the authorized user's data will be altered in the database by the system. In both pages, the clear button will clear the text boxes of any data, and the cancel button will return the user of the master account to the master account main page shown in FIG. 4.

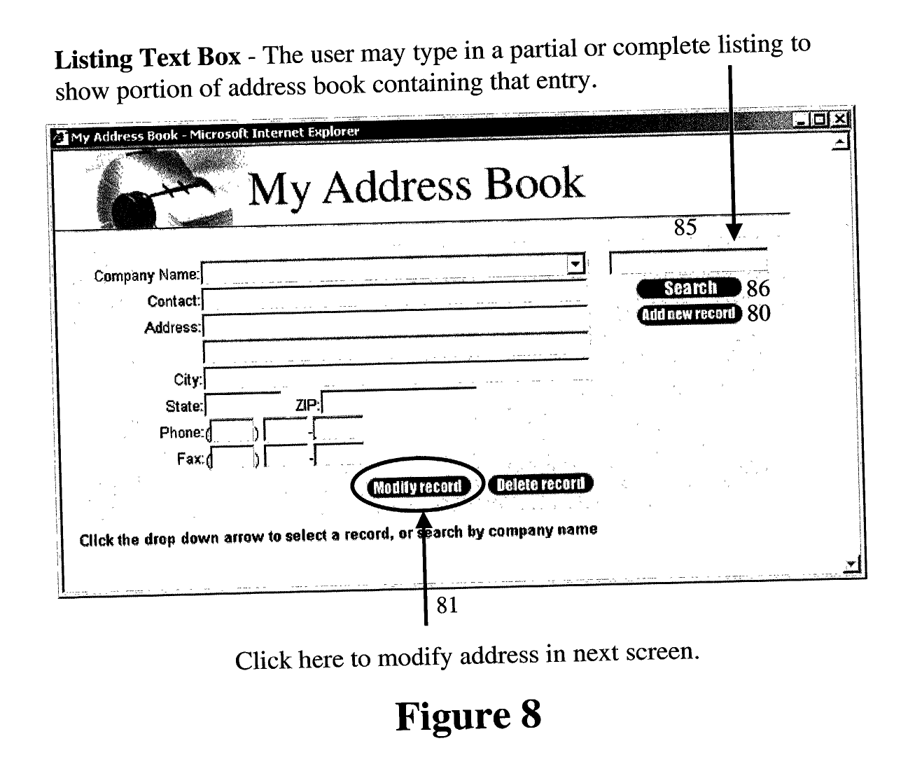

FIG. 8 shows an address book management page for the master account for a web-based version of the invention. Selecting the customer address book link 43 at any time will take the user of the master account to the address book management page. FIG. 8 shows the preferred address book page accessed by the user of the master account. In the preferred embodiment, the user of the master account may view addresses and may add or modify addresses already existing in the database. Upon viewing the address book management page, the system will format the addresses stored in the database for that master account, and provide links for each address, presenting the addresses to the user of the master account in the form of a web page. Addresses are sorted and displayed by company name. Addresses stored in the database include both addresses added by the user of the master account and the addresses of each subaccount. By clicking on the ‘Add a New Record’ button 80 the user of the master account may add a new address. By clicking on the modify record button 81, the user of the master account may access pre-existing addresses and modify them. In addition, the user of the master account may search for an individual listing in the address book by typing a partial or complete listing into the ‘Listing Text Box’ 85 and clicking the ‘Search’ button 86. The search will take place by company name, and the displayed web page will scroll or alter to show the portion of the address book containing that entry, if any match is located in the database by the system.

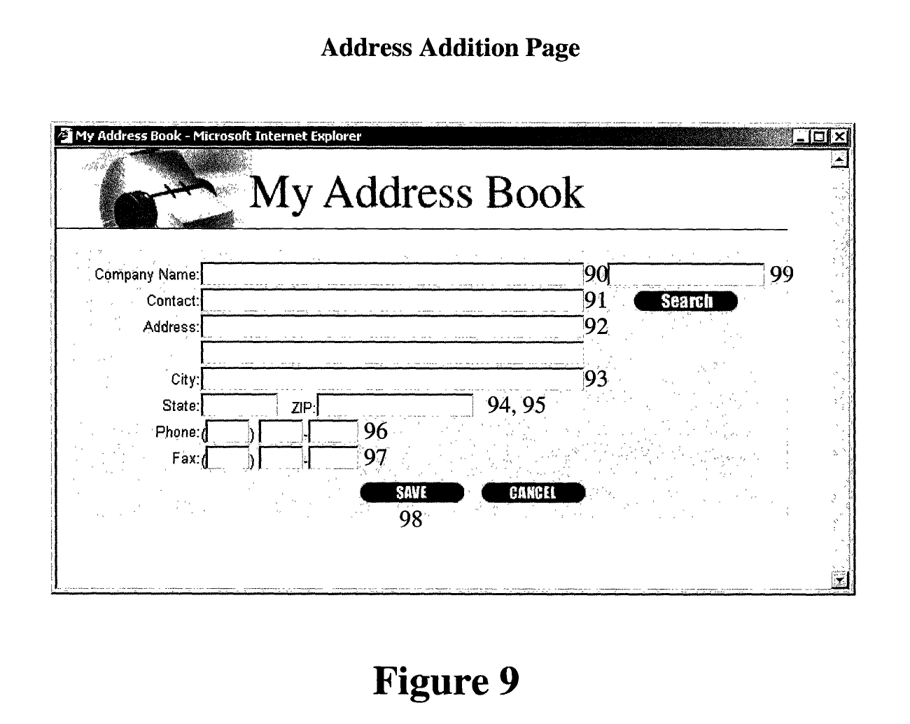

FIG. 9 shows an address addition page for the master account for a web-based version of the invention. The address addition page has a number of text boxes which are determined by the database of addresses. In the preferred embodiment, this includes ‘Company Name’ text box, 90, ‘Address’ text box 91, ‘Contact’ text box 92, ‘City’ text box 93, ‘State’ text box 94, ‘Zip’text box 95, ‘Phone’ text boxes 96 and ‘Fax’ text boxes 97. By pressing ‘Save’ button 98, the address is added to the address book. The system will make the appropriate changes and additions to the database, and then return the user to the address book display page shown in FIG. 9.

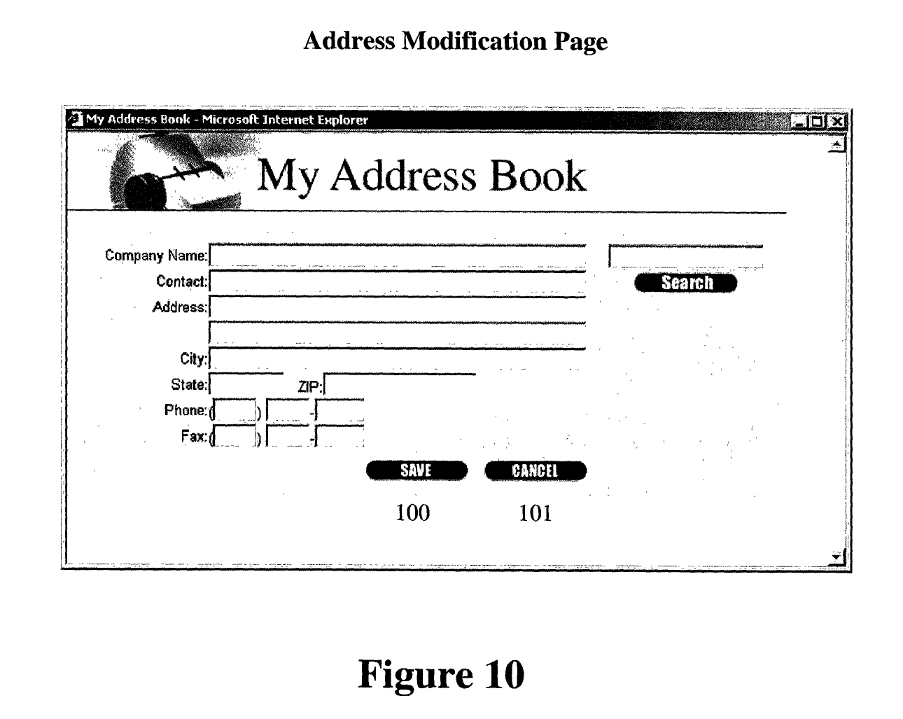

FIG. 10 shows an address modification page for the master account for a web-based version of the invention. The address modification page works similarly to the address addition page (FIG. 9) save that the text boxes will contain information for the address being modified when the page is accessed and ‘Save’ button 100 will submit changes to the database while ‘Cancel’ button 101 will restore the original information from the database, permitting the user to either make a different change or no change.

All of the addresses stored by the system will be visible to any authorized user of the master account. The system may be configured to permit only limited access to the address book by users of limited access subaccounts. Regardless, users of limited access subaccounts will not be permitted to ship to all locations within the address book, but only those addresses which are permitted to that limited access subaccount. In the preferred embodiment, the users of limited access subaccounts are limited to shipping to the address of the master account itself or to the addresses of complete access subaccounts, which will also appear as part of the address book. It may readily be seen, however, that alternative arrangements, limiting the limited access subaccounts to a different, but restricted set of addresses for shipping to and/or from, are possible, and are well within the scope of the invention.

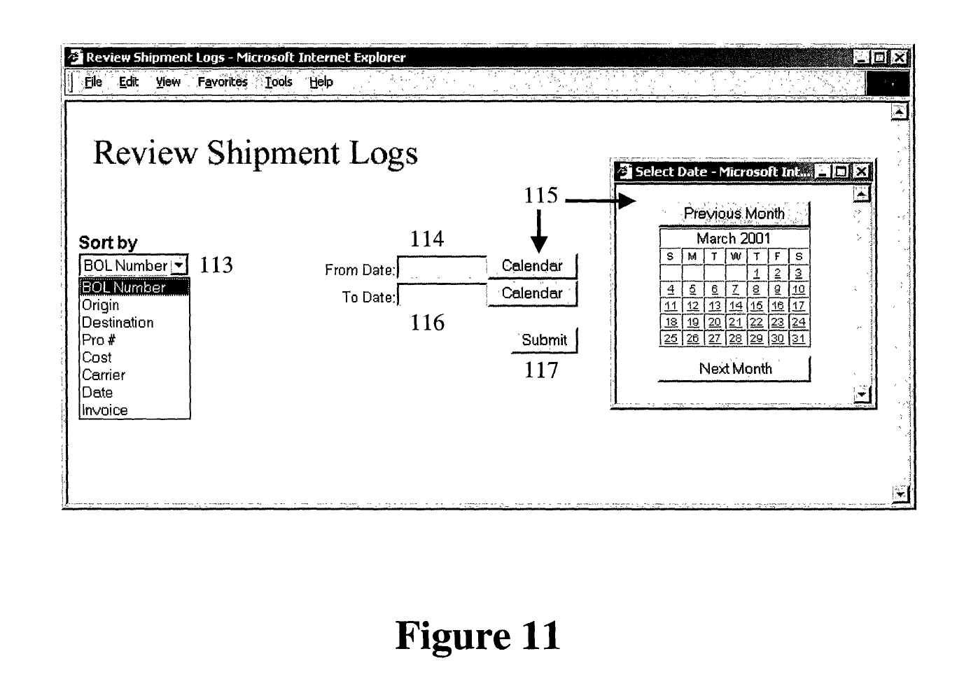

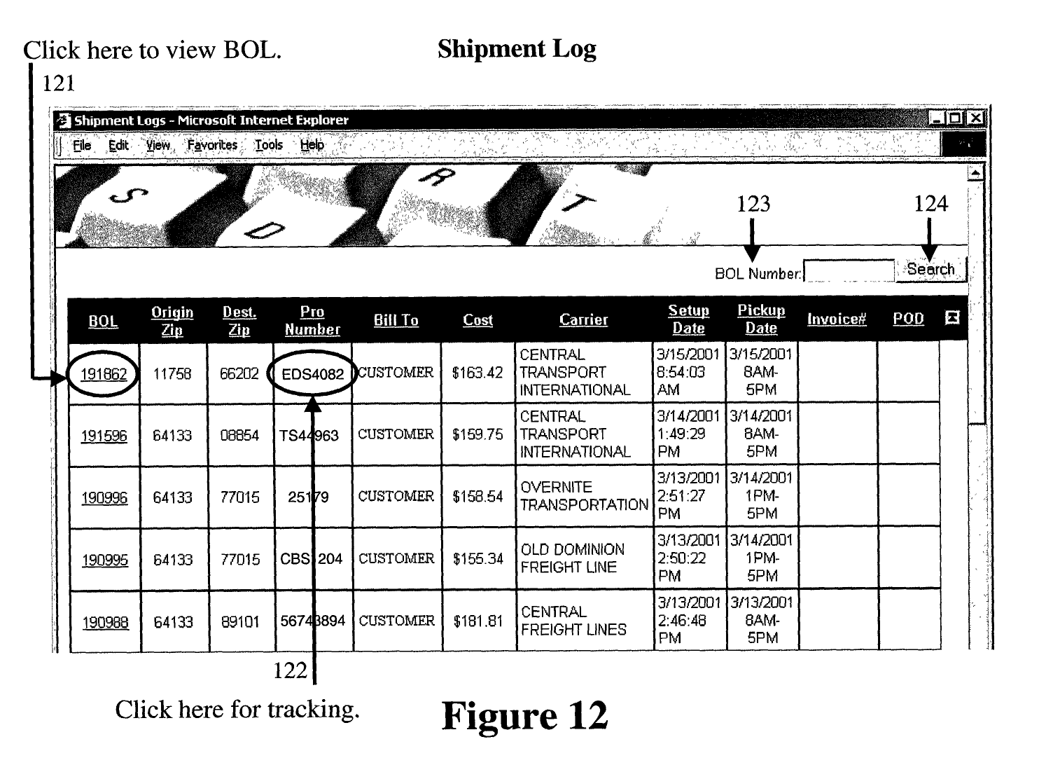

FIG. 11 shows a request to review shipment logs page for the master account for a web-based version of the invention. This page permits the user of the master account to access shipping activity reports for the whole account, for limited access accounts, and for complete access accounts. The user selects one of BOL number, Origin Zip, Destination Zip, Pro Number, Cost, Carrier, Date and invoice to view the report by selecting one of them from category drop down box 113. The default is BOL number. The user may then enter the range of dates for which he wishes to see the report by entering the start and end dates into ‘start date’ date box 114 and ‘end date’ date box 116. Calendar buttons 115 also permit the user to select those dates from a displayed calendar, which the system will then place into date box 114 or 116. Once the access level, sorting category, and date ranges have been selected, the user may click submit button 117 and the system will display a shipment log (see FIG. 12) to the user. Similar shipping activity reports are available, via a similar web page, to users of subaccounts. Those users, however, will only be able to view shipment logs for the subaccount with which they are associated.

FIG. 12 shows a sample shipment log for the master account for a web-based version of the invention. The shipment log is a web page which permits access to the bills of lading for each shipment as well as tracking information. The sample shipment log displays the shipment data in a columnar format, sorted as specified on the shipping activity report page (FIG. 11). In the master account report, the rows show the BOL number, Origin Zip, Destination Zip, Tracking Number, Pro Number, Bill to, Cost, Carrier, set up date, Pickup Date, invoice #, and POD for each shipment shipped using the master account, or any subaccount. Subaccounts may also access shipment reports. Complete access accounts may be permitted to view some or all of the shipments made under the master account. Likewise, limited access accounts are typically permitted to view only shipments to or from them, but additional access may be permitted. There are two special sets of data displayed. BOL Number data is displayed in the form of BOL links 121, and Pro Number data is displayed in the form of Pro Number links 122. These links permit the user to track the shipment (by clicking on the Pro Number link for the appropriate shipment) or to view the BOL for the shipment (by clicking on the BOL link for the appropriate shipment). In addition, the user may search for a specific BOL by entering the desired BOL number in BOL text box 123 and clicking on search button 124. If such a BOL exists, the system will scroll or alter the display to contain the appropriate shipment, which may then be tracked or have the BOL viewed as normal.

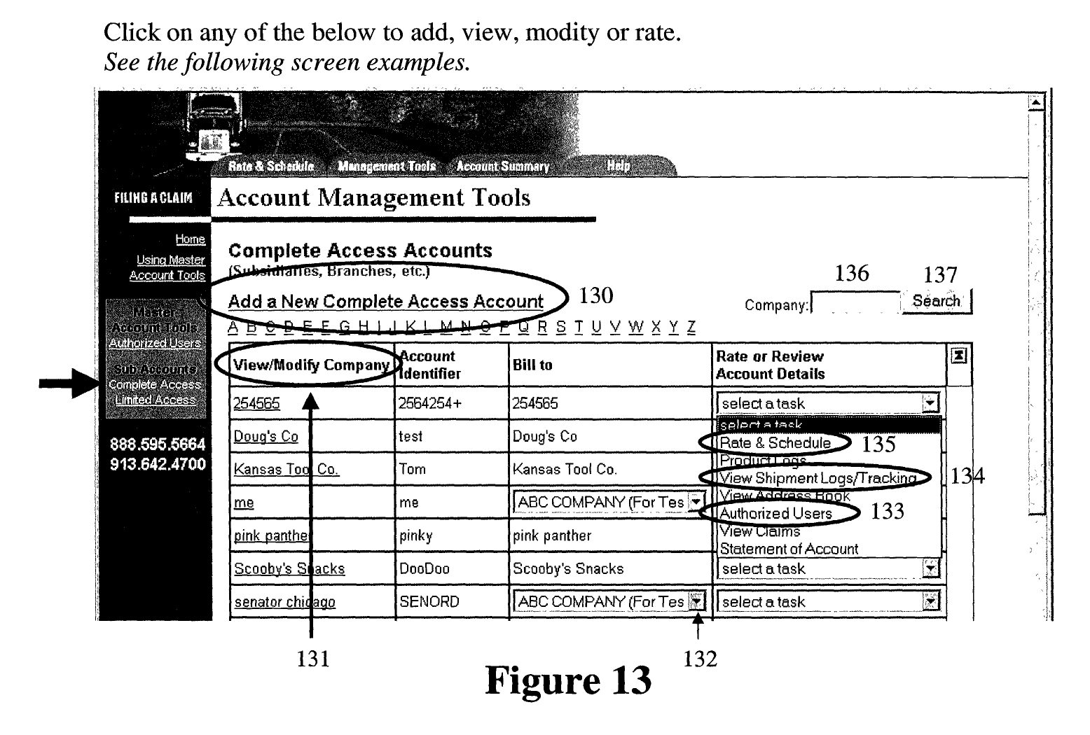

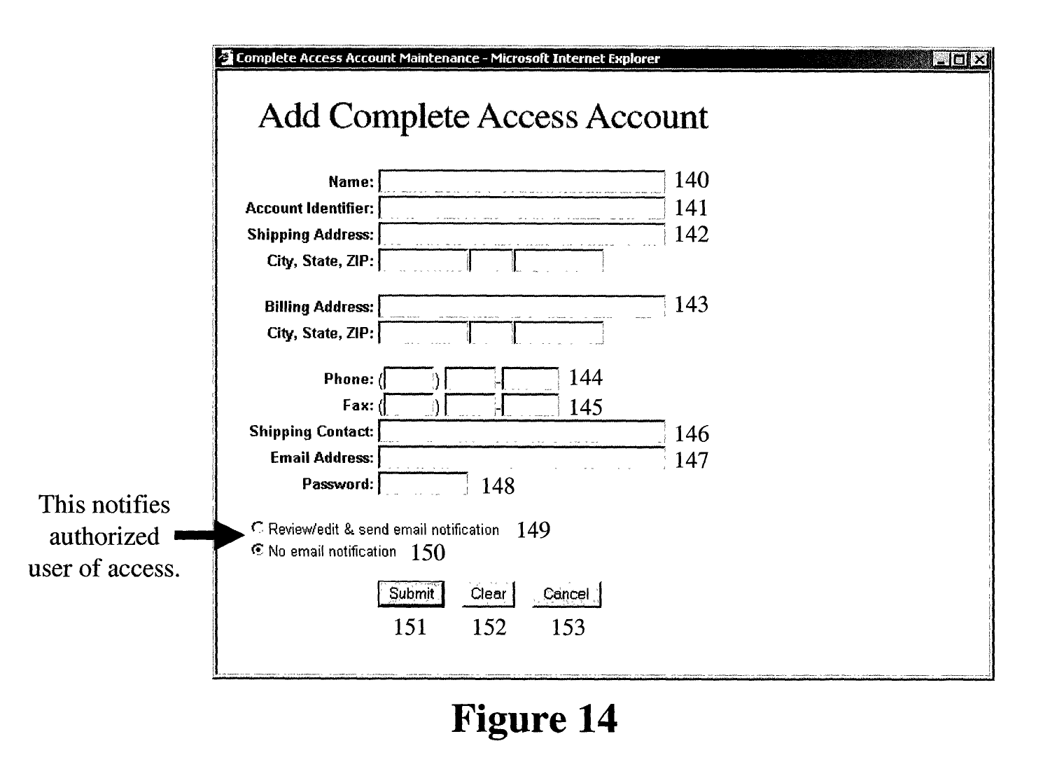

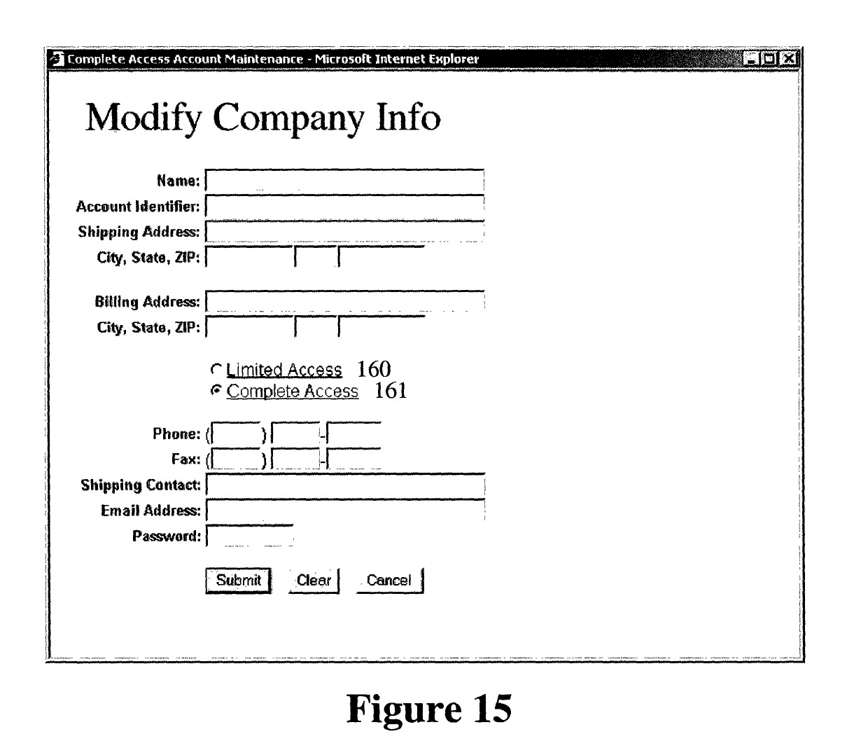

FIG. 13 shows the Complete Access Accounts page. From this page the user of the master account may add or modify complete access accounts. By clicking on Add a New Complete Access Account link 130 the user of the master account will be redirected to the Add New Complete Access Account page (FIG. 14). By clicking on the name of the account to be modified, which is displayed as one of existing complete access account links 131, the user will be redirected to the Modify Company Info Page (FIG. 15). In addition, the user may alter the billing of a complete access account by using one of billing drop down boxes 132. The billing drop down box 132 for each account will permit the user of the master account to change the entity to whom the shipments made by the subaccount will be billed, generally either the subaccount (such as in the case of a subdivision or department of the master account) or the master account itself. The user may also modify authorized users for the subaccount by clicking on the Authorized Users link 133 for that subaccount. The modification pages are similar in form and function to those shown in FIGS. 6 and 7, but the authorized users will be users of the specific subaccount, rather than of the master account. Likewise, the view logs links 134 will permit the user of the master account to view logs limited to a specific subaccount, exactly as described in FIGS. 11 and 12, but limited to shipments made under the subaccount whose view logs link 134 was used. Finally, the user may rate and schedule shipments for any of the subaccounts themselves by selecting the rate and schedule shipments link 135 for the appropriate account. A complete access subaccount will be permitted all of the shipping privileges accorded to the master account (i.e., they may ship to or from any location) but will not be granted access to maintain or alter the master account or subaccounts themselves.

If the user chooses to add a new complete access account, the user will be taken to a page similar to that shown in FIG. 14, the Add New Complete Access Account page. By entering the appropriate information into name text box 140, account identifier text box 141, shipping address text boxes 142, billing address text boxes 143, phone text boxes 144, fax text boxes 145, shipping contact text boxes 146, email address text box 147, and password text box 148, the user can add a new complete access account for the master account for the database upon pressing submit key 151. The system will then add a new complete access subaccount to the database for that master account. If send email radio button 149 has been clicked prior to the submittal, the system will send a notification of the new subaccount's creation and access to the email specified in email text box 147. If no email radio button 150 has been clicked prior to the submittal, or if neither button has been clicked, then no such email will be sent. Clear button 152 will clear all of the text boxes and restore the no email radio button 150 to a clicked state (the default). Cancel button 153 will return the user to the previous Complete Access Accounts page (FIG. 13) without submitting the data to the system.

FIG. 15 shows a Modify Company Info page. This page works similarly to that shown in FIG. 14, however, the system will fill the text boxes with the data for the complete access account whose link 131 was selected on the Complete Access Accounts page (FIG. 13), permitting easier modification of the account. In addition, radio buttons are provided to permit the user of the master account to convert the account to a limited access account. Limited Access radio button 160 will be clicked prior to the submission of any modifications in order to change the account from a complete access account, and Complete Access account radio button 161 may be clicked prior to submission to maintain the account as a complete access account. (A similar page is used to change limited access accounts to complete access accounts.)

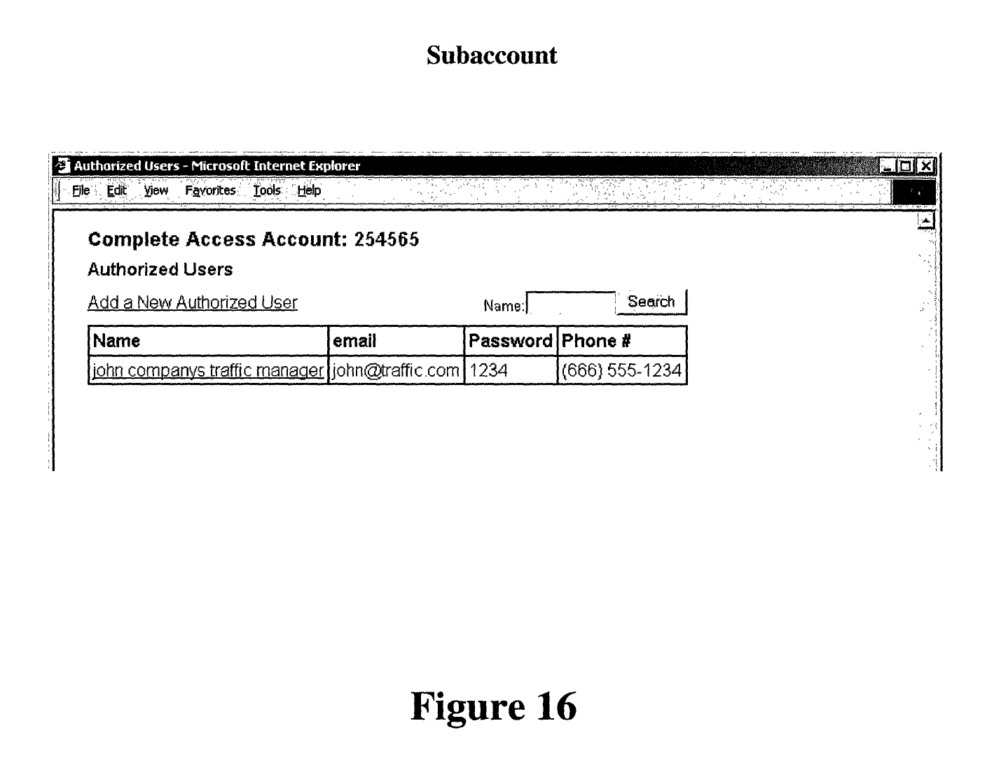

Figure 16 is an authorized user page for a subaccount. It works exactly like the page shown and described in FIG. 6, save that the user added will be for the subaccount only. A similar page is used for limited access subaccounts.

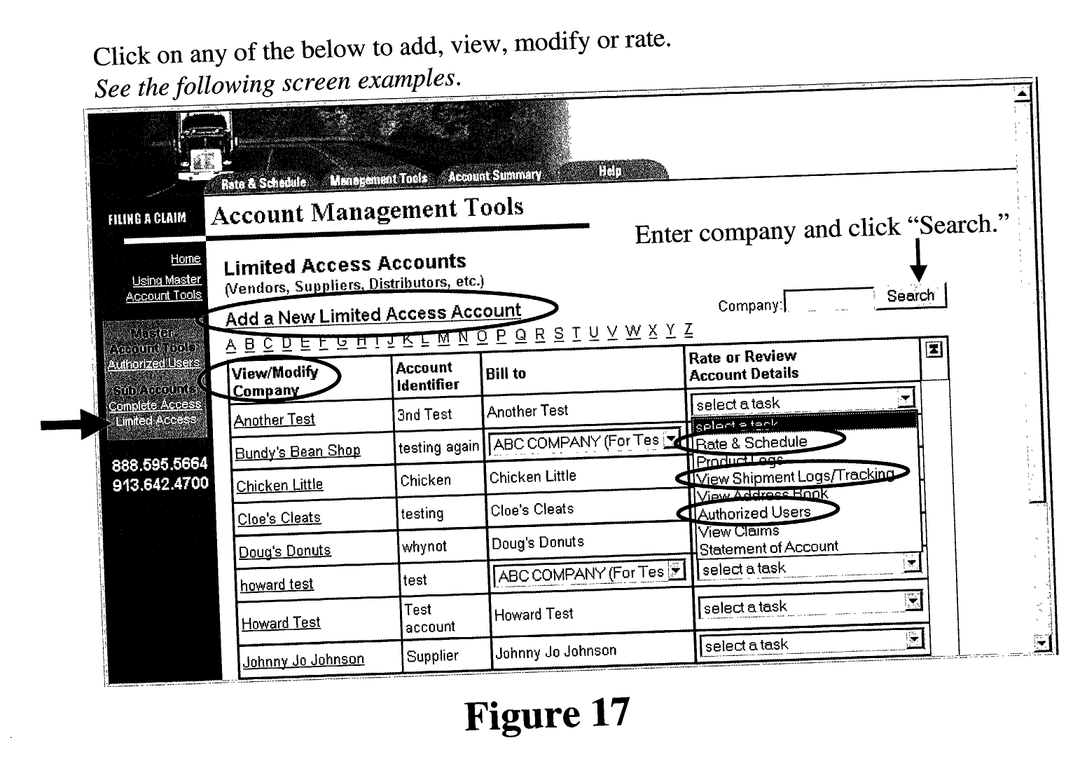

FIG. 17 shows a Limited Access Account page. The Limited Access Accounts page works exactly like the Complete Access Accounts page shown at FIG. 13, save that only limited access subaccounts are displayed to the user of the master account to permit addition, modification or deletion.

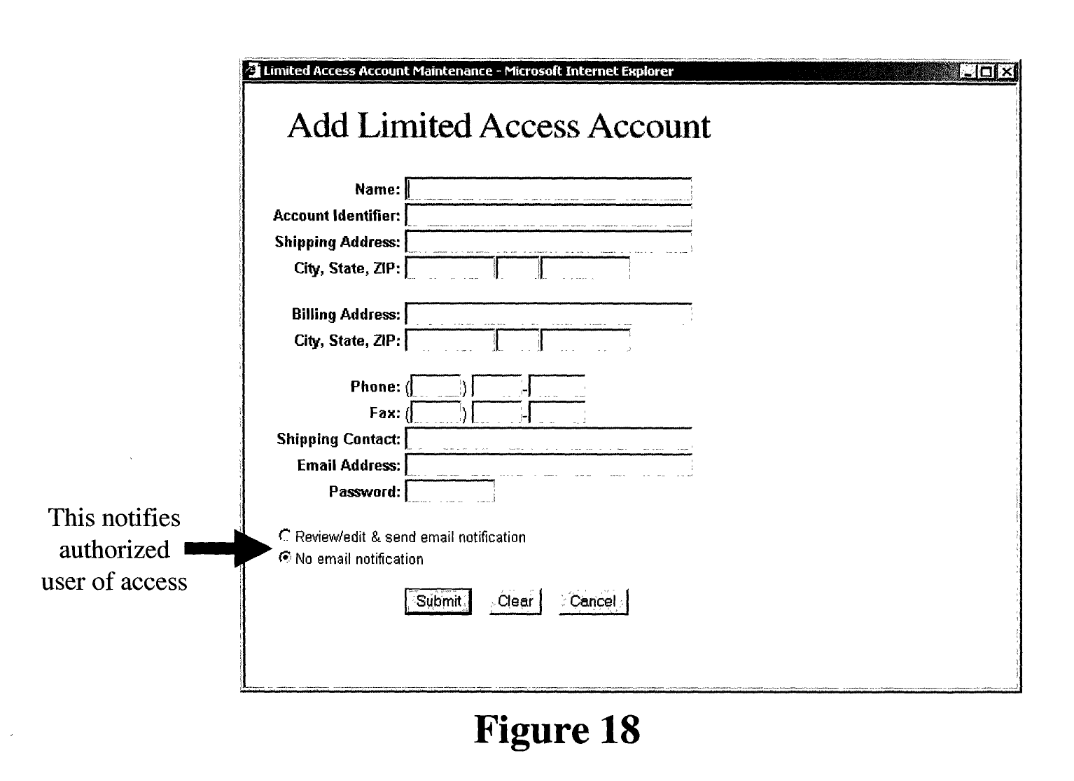

FIG. 18 shows an Add Limited Access Account page. This page is similar to the Add Complete Access Account page shown at FIG. 14, save that it will permit the user to add a new limited access account rather than a complete access account.

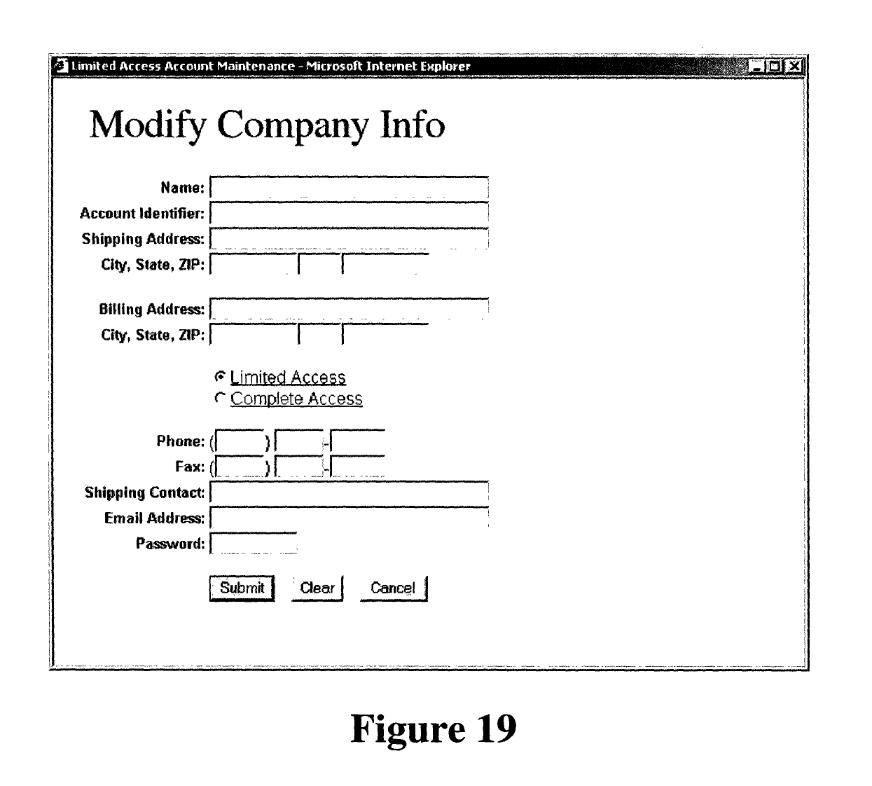

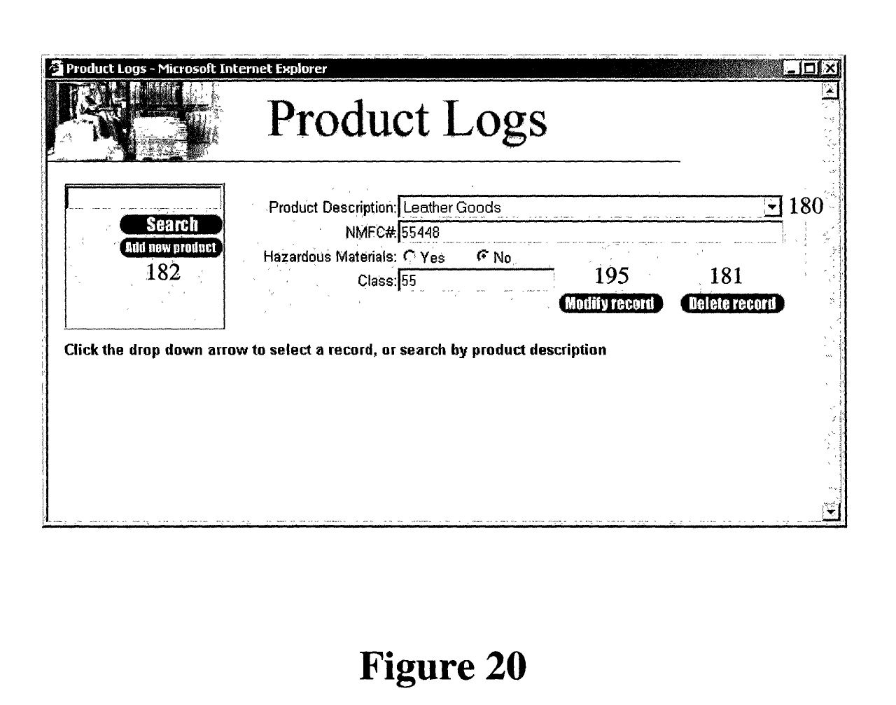

FIG. 19 shows a Modify Company Info page. This page is similar to the Modify Complete Access Accounts page shown at FIG. 20, save that it will permit the user to modify limited access subaccounts, or change them to complete access subaccounts.

FIG. 20 shows the Product Loop page for the system. The user of the master account may view and add products which are shipped by the members of his supply chain when scheduling and rating shipments. By clicking on the Add new product button 182, the user may add a new product to the database for all the members of his supply chain. By clicking on the Delete Record button 181 for a specific product, the user may delete the given product and description from the database. By clicking on one of product description from the pull down menu 180, the user will be permitted to modify the description of that product.

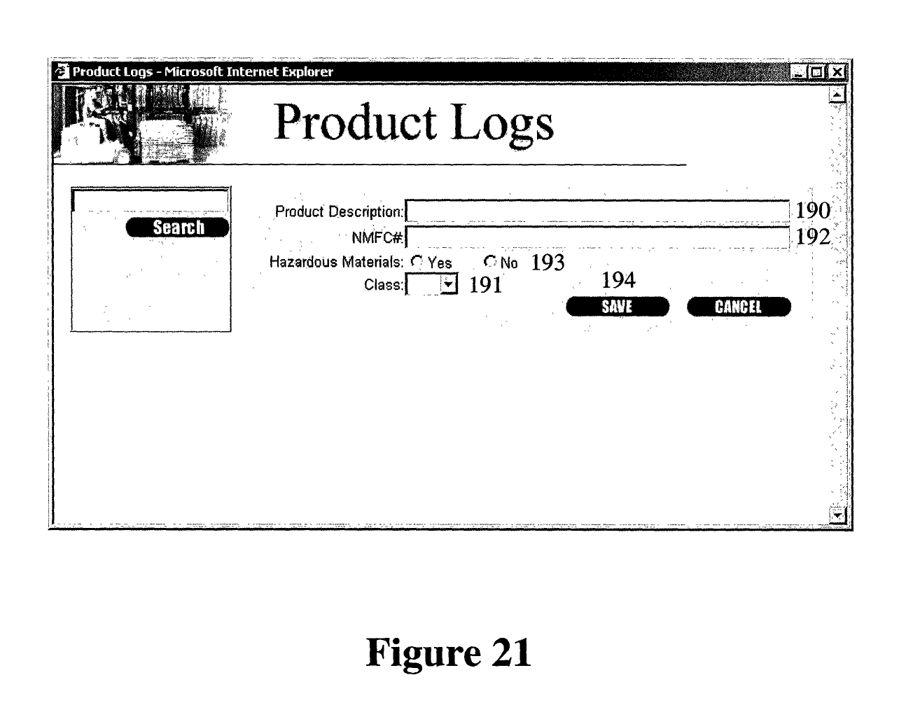

FIG. 21 shows blank product logs page. By entering the appropriate information into product description text box 190, Class drop down box 191, NMFC# text box 192 and hazardous materials check box 193, then clicking save button 194, the user may add a new product to the database for the supply chain. Modify record button 195, will result in FIG. 21. In the event the user clicks on the link 180, the system will fill the boxes, drop down and check box as appropriate for the product selected. Subaccounts may also be permitted to add products to the database which they will then be able to access.

It will be apparent to those of ordinary skill in the art that many changes and modifications could be made while remaining within the scope of the invention. It is intended to cover all such equivalent methods or systems, and to limit the invention only as specifically delineated in the following claims.

It is readily apparent that the claimed invention may be embodied in a number of manners. Though the disclosed embodiment, and the currently preferred embodiment, is a series of web pages run on a web server and a database server, the invention could be a network-based program run over a distributed system, a set of web pages run on a single server or distributed server, or any other alternative which may be immediately apparent to one skilled in the art, and that advances in distributed networks may make possible embodiments which are not presently available without making substantial changes to the invention.

The above description is not intended to limit the meaning of the words used in the following claims that define the invention. Rather, it is contemplated that future modifications in structure, function or result will exist that are not substantial changes and that all such insubstantial changes in what is claimed are intended to be covered by the claims.

What is claimed is:

1. A method of coordinating shipping over a network comprising:
providing a master account to a customer;
said master account providing the customer the ability to create and alter subaccounts;
said master account also permitting said customer to maintain and manage a database of shipping information for a supply chain;
said supply chain comprising the master account and subaccounts of said master account; and
said master account also permitting said customer to manage billing for shipping activities of said supply chain.

2. The method of claim 1 wherein said subaccounts may be either limited access accounts or complete access accounts;
a limited access account being a subaccount with restricted ability to ship within the supply chain; and
a complete access account being a subaccount with unrestricted ability to ship.

3. A system for coordinating shipping for a supply chain comprising:
a) a server computer;
b) a network connected to said server computer;
c) a database containing account information and shipping information and
d) programs or software on said server enabling a customer to manage and maintain a master account and subaccounts for shipping.
